(19) United States
(12) Patent Application Publication
(10) Pub. No.: US 2006/0015896 A1
(43) Pub. Date: Jan. 19, 2006

(54) Selective commercial broadcasting

(76) Inventor: Wang Su, East Patchogue, NY (US)

Correspondence Address: Wang Su, 154 Donegan Ave., East Patchogue, NY, 11772, US

(21) Appl. No.: 10/889,164

(22) Filed: Jul. 13, 2004

(51) Int. Cl. H04N 7/10; H04N 7/025

(52) U.S. Cl. 725/32; 725/35

(57) ABSTRACT

A system and method for selectively broadcasting commercials wherein a control device receives at least one input from a viewer regarding her preferred commercials and then either selects commercials using the input as at least one selection criterion or passes the input onto a computer system which selects commercials using the input as at least one selection criterion.

### FIELD OF INVENTION

The present invention is generally related to the broadcasting industry and, in particular, to a system and method for selectively broadcasting television commercials.

### BACKGROUND OF THE INVENTION

Television commercial is a major component of the broadcasting industry. The broadcasting industry, including numerous large and small television networks, mostly relies on television commercial as a major income source. On the other hand, companies all over the world depend on these commercials to send out messages regarding their products and services to millions of viewers.

Currently, viewers have little control over what kind of commercials they are going to see on their televisions. Commercials are largely imposed on them. The broadcasters determine what commercials are to be played and in what order, and insert these commercials in between or in the middle of different shows and programs to force the viewers to look at them.

The current method has some fundamental flaws. Because the viewers have little control over what commercial they are going to see, they often view the commercials as irrelevant to their needs and therefore either pay little attention to them or simply switch channels. This situation hurts the companies that are financing these commercials as well, because after spending significant amount of money making and broadcasting these commercials, their messages are largely ignored by most of the audience.

As a result, there exists a long felt need to catch the attention of the viewers and match commercials with the need of those different viewers at the time when they watch the commercials.

Some attempts have been made to solve this problem. For example, companies marketing certain type of products tend to place their commercials on channels that target a corresponding type of consumers. One good example is that commercials on toys and games are likely to appear on cartoon channels because the core audience of cartoon channels are children. However, this approach still leaves the audience with little control over what commercials they are going to see each time when they watch the channels, and the viewers, in spite of what kind of groups they may belong to, may not be interested in commercials that target those groups at the moment when they are watching the channels. Moreover, there are channels the audience of which have a wide variety of backgrounds and can not be easily categorized into one or two simple consumer groups.

This invention provides a solution that helps alleviating this long existing problem as described in detail below.

### BRIEF DESCRIPTION OF THE DRAWING

FIG. 1 is a block view of an embodiment of a system for selective commercial broadcasting.

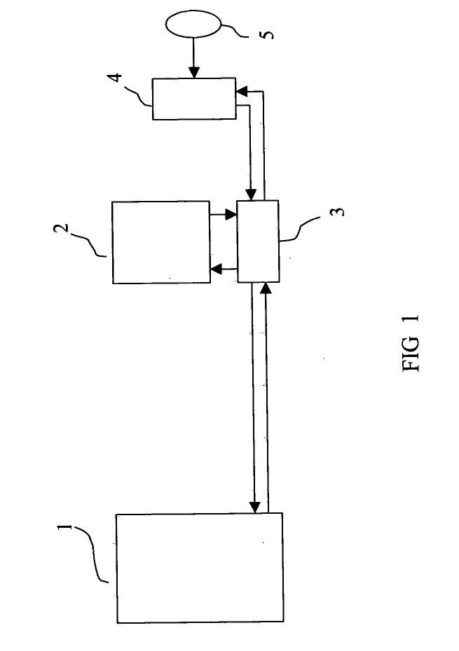

### DETAILED DESCRIPTION OF THE DEARWING AND POSSIBLE EMBODIMENTS OF THE INVENTION

Possible embodiments of the invention are discussed in this section. According to one embodiment of the invention, the broadcaster maintains a number of commercials that are ready to be played to the viewers over a television network. These commercials may be grouped into different categories according to their contents, such as cars, books, clothing, etc. They may also be marked or grouped according to their importance or priorities, such as “must shown”, “high priority”, “median priority”, or “low priority”.

According to one possible embodiment of the invention, the broadcaster records the times that a particular commercial has been transmitted to or played at a particular display such as a particular television set. Such information could be recorded either in a centralized location, such as a computer station, or in a device near the television set, such as a cable box.

According to one embodiment of the invention, a viewer (5) may input one or more preferred categories of commercials at a time with an input device (4). Such input device (4) may be a remote control, a keyboard, or simply electrical circuits with input buttons coupled to a cable box or a display (2) such as a television set.

The viewer's input may then be sent to a control device (3) by the input device (4). The control device (3) may be a stand a lone device, such as a cable box. It may also be built within the same casing as the display (2). The control device (3) then may process the input to select commercials using the input as at least one selection criterion, or pass it onto a computer system (1). The computer system (I) may be programmed to select commercials for broadcasting using one or more criteria including the viewer's input as one key criterion. The selected commercials may then be transmitted to the display of the viewer from whom the input is received.

For example, if the viewer inputs “car” as the preferred category, then the control device (3) or the computer system (1) may select commercials in the car category. If the viewer inputs “car” and “movie” as the preferred categories, then the control device (3) or the computer system may select commercials in both the car category and the movie category.

At the same time, the computer system (1) may also include as selection criteria the relevant priorities of the commercials in each category or in different categories. Such as commercials with higher priorities within the selected categories may be shown first and commercials with lower priorities may be shown later. Commercials marked as “must shown” may be included, even though a different category may have been selected by the viewer. The computer system (1) may also include as a selection criterion the times each commercial has been shown on a specific television. For example, commercials within the selected category and having similar priorities may be selected in an order that favors those that have been shown the least.

According to one possible embodiment of the invention, the computer system (1) is shared among multiple control devices and multiple displays serving multiple viewers, each control device having an input device. The computer system (1) may be programmed to respond to each control device separately, to make selections based on the inputs received from each control device, and transmit the selected commercials to the same control device or to the display coupled to the same control device. The computer system (1) may also be programmed to collect the inputs from multiple control devices and transmit to these control devices simultaneously commercials selected according to the collected inputs.

According to one embodiment of the invention, the computer system (1) pre-selects commercials and separate them into different groups corresponding to a number of preset viewer inputs. Once an input is received from a control device, the group of pre-selected commercials corresponding to such input will then be transmitted to the control device or the display coupled to the control device.

According to one embodiment of the invention, the broadcaster may provide a default setting. If no input regarding the preferred commercial categories was received from a certain control device, then commercials transmitted to that control device or the display coupled to that control device will be selected according to the default setting.

The broadcaster may also record the selections made by a viewer during the last input. Before a new input is received from the control device used by that viewer, the computer system (1) may select and transmit commercials based on the last input received from that control device regarding preferred commercial categories.

When multiple viewers share the same control device (3) or display (2), the broadcaster may treat them as one viewer or may establish files for different viewers. These files could be stored either in the computer system (1) or in the control device (3). Each file may correspond to a certain viewer and record the selection made by that viewer during the last input regarding preferred commercial categories. When a viewer having a file inputs her identity or file name into the control device, the broadcaster may retrieve the information contained in her file and select commercials for display accordingly.

According to another possible embodiment of the invention, the computer system (1) may send out multiple groups of commercials at the same time, each group having one or more than one category of commercials bundled together. The control device (3) may select at least one group of commercials for display. The selection may be based at least partially on the input it received from the input device (4), or the input that was stored in a storage.

It is obvious that there are numerous different variations and combinations of the above described embodiments of the invention. All these different variations, combinations and their equivalences are foreseen and considered as part of the invention. The invention is further defined and claimed by the following claims.

I claim:

1. A process for selectively broadcasting commercials comprising the steps of receiving at least one input from at least one control device, selecting commercials using the at least one input as at least one selection criterion, and transmitting the selected commercials for display.

2. The process of claim 1 further comprising the step of storing at least one recent input.

3. The process of claim 2 further comprising the step of using the at least one stored input as at least one selection criterion until at least one new input is received.

4. The process of claim 3 further comprising the steps of receiving at least one new input from the control device and selecting commercials for transmission using the at least one new input as at least one selection criterion.

5. The process of claim 1 further comprising the step of recording the times that a selected commercial has been transmitted for display.

6. The process of claim 5 further comprising the step of prioritizing the selected commercials using the times that a selected commercial has been transmitted for display as at least one criterion for prioritization.

7. A process for selectively broadcasting commercials comprising the steps of arranging commercials into groups, transmitting more than one group of commercials to at least one control device, receiving at least one input from at least one input device, and selecting at least one group of commercials by the control device for display using the at least one input as at least one selection criterion.

8. The process of claim 7 further comprising the step of storing at least one recent input.

9. The process of claim 8 further comprising the step of using the at least one stored input as at least one selection criterion until at least one new input is received.

10. The process of claim 9 further comprising the steps of receiving at least one new input from the input device and selecting commercials for display using the at least one new input as at least one selection criterion.

11. The process of claim 9 further comprising the step of establishing at least one file for at least one viewer.

12. A process for selectively broadcasting commercials comprising the steps of prearranging commercials into categories in accordance with the contents of the commercials, receiving at least one input from at least one input device, selecting commercials in at least one prearranged categories using the at least one input as at least one selection criterion, and transmitting the selected commercials for display.

13. The process of claim 12 further comprising the step of storing at least one recent input.

14. The process of claim 13 further comprising the step of using the at least one stored input as at least one selection criterion until at least one new input is received.

15. The process of claim 14 further comprising the steps of receiving at least one new input from the input device, and selecting commercials in at least one prearranged categories for transmission using the at least one new input as at least one selection criterion.

16. The process of claim 12 further comprising the step of recording the times that a commercial has been transmitted for display.

17. A system for selectively broadcasting commercials comprising a computer system, a control device, and an input device wherein at least one of the computer system and the control device is programmed to be able to select commercials using at least one input received from the input device as at least one selection criterion.

18. The system of claim 17 wherein the control device and the input device are built within one casing.

19. The system of claim 17 further comprising a display electronically coupled to the control device.

20. The system of claim 17 furthering comprising at least one storage device for storing inputs or commercials in electronic form.
